(19) United States
(12) Patent Application Publication
(10) Pub. No.: US 2021/0304018 A1
(43) Pub. Date: Sep. 30, 2021

(54) SYSTEMS AND METHODS FOR PREDICTING AGENT TRAJECTORY

(71) Applicant: Lyft, Inc., San Francisco, CA (US)

(72) Inventors: Muhammad Usman, Sunnyvale, CA (US); Tirthkumar Nilaykumar Pandya, Foster City, CA (US); Sammy Omari, Los Altos, CA (US); Ana Sofia Rufino Ferreira, Berkeley, CA (US)

(73) Assignee: Lyft, Inc., San Francisco, CA (US)

(21) Appl. No.: 16/836,666

(22) Filed: Mar. 31, 2020

(51) Int. Cl. G06N 5/02; G06F 11/34

(52) U.S. Cl. CPC G06N 5/02; G06F 11/3409

(57) ABSTRACT

Systems, methods, and non-transitory computer-readable media can receive a context comprising attributes associated with an agent. The attributes associated with the agent can be determined based at least in part on sensor data captured by at least one vehicle. A plurality of trajectory prediction algorithms to be applied to the agent can be evaluated to generate a plurality of performance metrics associated with the plurality of trajectory prediction algorithms. A particular trajectory prediction algorithm of the plurality of trajectory prediction algorithms that is to be applied to the agent can be determined based on evaluating the context against the plurality of performance metrics. The context can be associated with a particular cluster of a plurality of clusters of contexts such that the particular trajectory prediction algorithm is associated with the particular cluster.

### FIELD OF THE INVENTION

The present technology relates to the field of vehicles. More particularly, the present technology relates to systems, apparatus, and methods for determining agent trajectory for vehicle navigation.

### BACKGROUND

Vehicles are increasingly being equipped with intelligent features that allow them to monitor their surroundings and make informed decisions on how to react. Such vehicles, whether autonomously, semi-autonomously, or manually driven, may be capable of sensing their environment and navigating with little or no human input. For example, a vehicle may include a variety of systems and subsystems for enabling the vehicle to determine its surroundings so that it may safely navigate to target destinations or assist a human driver, if one is present, with doing the same. As one example, the vehicle may have a computing system for controlling various operations of the vehicle, such as driving and navigating. To that end, the computing system may process data from one or more sensors to permit such functionality of the vehicle. For example, the vehicle may have optical cameras that capture visual data of its surroundings. The vehicle can process visual data captured by the optical cameras to recognize various features. For example, the vehicle can process the visual data to recognize road features, such as hazards, roads, lane markings, traffic signals, and the like. The vehicle can also process the visual data to detect various agents (e.g., pedestrians, vehicles, objects, etc.) present in the surrounding environment and to determine their respective trajectories. In general, a trajectory associated with an agent represents a path to be taken (or expected to be taken) by the agent. For example, the vehicle can predict a trajectory of a bicyclist recognized in its surrounding environment. The predicted trajectory can describe changes to a location (or position) of the bicyclist over some period of time. For example, the predicted trajectory can indicate that the bicyclist is expected to be located at a first location in the environment at a first time and a second location in the environment at a second time. Thus, accurate prediction of agent trajectories is needed to enable the vehicle to effectively and safely navigate its surroundings.

### SUMMARY

Various embodiments of the present technology can include systems, methods, and non-transitory computer readable media configured to receive a context comprising attributes associated with an agent. The attributes associated with the agent can be determined based at least in part on sensor data captured by at least one vehicle. A plurality of trajectory prediction algorithms to be applied to the agent can be evaluated to generate a plurality of performance metrics associated with the plurality of trajectory prediction algorithms. A particular trajectory prediction algorithm of the plurality of trajectory prediction algorithms that is to be applied to the agent can be determined based on evaluating the context against the plurality of performance metrics. The context can be associated with a particular cluster of a plurality of clusters of contexts such that the particular trajectory prediction algorithm is associated with the particular cluster.

In an embodiment, a first observed position of the agent at a first time can be determined from the sensor data captured. The plurality of trajectory prediction algorithms can be applied to the agent at the first observed position to predict respective positions of the agent at a second time as predicted by the plurality of trajectory prediction algorithms. A second observed position of the agent at the second time can be determined from the sensor data captured. The second observed position can be compared against the respective positions to generate the plurality of performance metrics.

In an embodiment, the determining that the particular trajectory prediction algorithm is to be applied to the agent further comprises: determining values associated with the context indicative of at least one of a timing criterion or a priority; determining a processing time associated with the particular trajectory prediction algorithm based on the plurality of performance metrics; and determining that the processing time satisfies the timing criterion or the priority.

In an embodiment, the attributes associated with the agent have values that are determined based at least in part on semantic map data and localization data associated with the agent.

In an embodiment, an outlier context absent in the plurality of clusters can be determined. An additional trajectory prediction algorithm can be added to the plurality of trajectory prediction algorithms. The outlier context can be associated with the additional trajectory prediction algorithm.

In an embodiment, a particular context associated with a particular agent can be provided. That the particular context is associated with the particular cluster can be determined. The particular trajectory prediction algorithm can be selected based on the particular context being associated with the particular cluster. A trajectory for the particular agent can be selected based on the particular trajectory prediction algorithm.

In an embodiment, the particular cluster includes one or more other contexts. The particular trajectory prediction algorithm can be associated with the one or more contexts included within the particular cluster.

In an embodiment, one or more agents associated with the one or more other contexts can be determined. At least one trajectory for the one or more agents can be determined using the particular trajectory prediction algorithm.

In an embodiment, the context comprises a plurality of agents including the agent, wherein the plurality of agents are associated with a plurality of priorities. The plurality of agents can be ranked based on the plurality of priorities.

In an embodiment, the particular trajectory prediction algorithm can be tuned. The particular trajectory prediction algorithm can be evaluated on the agent to generate a performance metric associated with the first trajectory prediction algorithm.

It should be appreciated that many other features, applications, embodiments, and variations of the disclosed technology will be apparent from the accompanying drawings and from the following detailed description. Additional and alternative implementations of the structures, systems, non-transitory computer readable media, and methods described herein can be employed without departing from the principles of the disclosed technology.

### BRIEF DESCRIPTION OF THE DRAWINGS

FIGS. 1A-1B illustrate challenges that may be experienced by a vehicle when predicting trajectories for various agents and improvements thereof, according to an embodiment of the present technology.

FIG. 2 illustrates an example system including an example context-specific prediction module, according to an embodiment of the present technology.

FIG. 3 illustrates example attributes that can be associated with an agent, according to an embodiment of the present technology.

FIG. 4A-4C illustrate example diagrams of training a model to select a trajectory prediction algorithm based on a context and inferring a trajectory prediction algorithm to apply to the context, according to an embodiment of the present technology.

FIG. 5 illustrates an example diagram, according to an embodiment of the present technology.

FIGS. 6A-6C illustrate example methods, according to an embodiment of the present technology.

FIG. 7 illustrates an example block diagram of a transportation management environment, according to an embodiment of the present technology.

FIG. 8 illustrates an example of a computer system or computing device that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

Vehicles are increasingly being equipped with intelligent features that allow them to monitor their surroundings and make informed decisions on how to react. Such vehicles, whether autonomously, semi-autonomously, or manually driven, may be capable of sensing their environment and navigating with little or no human input. For example, a vehicle may include a variety of systems and subsystems for enabling the vehicle to determine its surroundings so that it may safely navigate to target destinations or assist a human driver, if one is present, with doing the same. As one example, the vehicle may have a computing system for controlling various operations of the vehicle, such as driving and navigating. To that end, the computing system may process data from one or more sensors to permit such functionality of the vehicle. For example, the vehicle may have optical cameras that capture visual data of its surroundings. The vehicle can process visual data captured by the optical cameras to recognize various features. For example, the vehicle can process the visual data to recognize road features, such as hazards, roads, lane markings, traffic signals, and the like. The vehicle can also process the visual data to detect various agents (e.g., pedestrians, vehicles, objects, etc.) present in the surrounding environment and to determine their respective trajectories. In general, a trajectory associated with an agent represents a path to be taken (or expected to be taken) by the agent. For example, the vehicle can predict a trajectory of a bicyclist recognized in its surrounding environment. The predicted trajectory can describe changes to a location (or position) of the bicyclist over some period of time. For example, the predicted trajectory can indicate that the bicyclist is expected to be located at a first location in the environment at a first time and a second location in the environment at a second time. Thus, accurate prediction of agent trajectories is needed to enable the vehicle to effectively and safely navigate its surroundings.

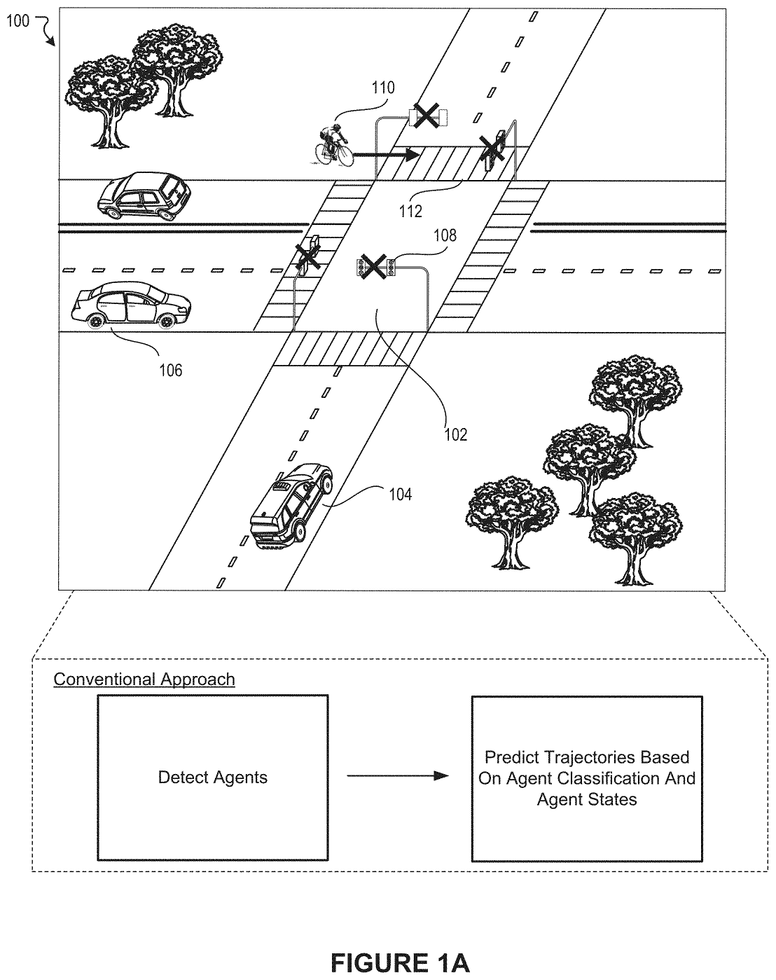

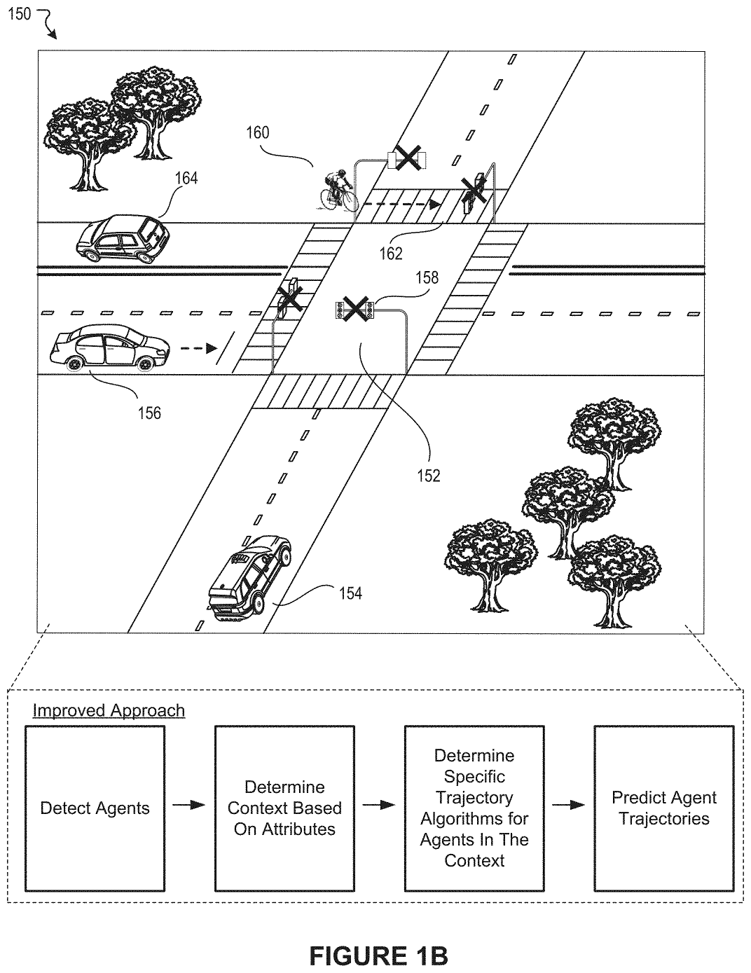

Under conventional approaches, an agent trajectory is determined by a trajectory prediction algorithm that is designed to be applicable to an agent based on agent classification and agent states. That is, the trajectory prediction algorithm serves the purpose of generating a trajectory prediction for, for example, a vehicle changing lane, a pedestrian waiting to cross an intersection, or a bicyclist making a left turn. However, selecting a trajectory prediction algorithm based on the agent classification and states of an agent, and using the trajectory prediction algorithm to predict a trajectory for the agent can be less than desirable because it does not fully account for a context associated with the agent. For example, the selected trajectory prediction algorithm may accurately predict trajectories for a vehicle changing a lane but the trajectory prediction algorithm will predict the same trajectory for the vehicle regardless of whether the vehicle is at an intersection with a traffic light or at an intersection with four-way stop signs. Experienced drivers are aware of special rules that pertain to an intersection with four-way stop signs, namely, (1) first vehicle to arrive has the right of way, and (2) if two vehicles arrive at the intersection at the same time, a vehicle on the right has the right of way. However, a trajectory prediction algorithm that is selected solely based on agent classification and states does not account for such context. Additionally, the conventional approaches do not take into account relevant context considerations, such as whether a lane a vehicle is in is shared with a bicyclist, whether the vehicle is in a school zone, whether the vehicle is approaching a roundabout, whether the vehicle can make a one-way to one-way left turn on a red traffic light, and whether the vehicle is likely to change lanes from a right turn only lane, for example. Further, the conventional approaches of selecting a trajectory prediction algorithm for an agent does not take into account performance metrics associated with the trajectory prediction algorithm. For example, a first trajectory prediction algorithm may be more accurate but slow when predicting a vehicle trajectory while a second trajectory prediction algorithm can be less accurate but faster at predicting vehicle trajectories. In some instances, a need for faster agent trajectory predictions may outweigh a need for more accuracy and, thus, it may be desirable to select the second trajectory prediction algorithm over the first trajectory prediction algorithm. FIG. 1A illustrates an example environment 100 in which a vehicle 104 is navigating. In this example, the vehicle 104 relies on a trajectory prediction algorithm based on agent classification and states to predict trajectories of agents, including a vehicle 106 and a bicyclist 110, detected in the environment 100. In the example of FIG. 1A, the vehicle 104 is approaching an intersection 102. To the left of the vehicle 104 is an incoming vehicle 106 that is also approaching the intersection 102. The environment 100 also includes the bicyclist 110 at a crosswalk 112. In this example, the traffic lights 108 are out of service and the intersection 102 can be analogized to a four-way stop sign intersection. Upon approaching the intersection 102, the vehicle 104 predicts, based on the incoming vehicle 106 that is decelerating, that the vehicle 106 is going to stop before the intersection 102. The vehicle 104 may further predict that, based on the trajectory prediction algorithm, that the bicyclist 110 is not going to enter the crosswalk 112. Based on the predicted trajectories, the vehicle 104 may determine to proceed through the intersection 102. However, in the example of FIG. 1A, the bicyclist 110 observes that the traffic lights are out of service and determines that the right of way is with the bicyclist 110. The bicyclist 110 proceeds across the crosswalk 112. As a result, the vehicle 104 ends up abruptly applying its breaks to avoid an undesirable interaction with the bicyclist 110, which could have been avoided if a more accurate trajectory prediction algorithm were aware of a context associated with the environment 100 including the out of service traffic lights 108 and the need for the vehicle 104 to come to a full stop at the intersection 102. Accordingly, other robust approaches are needed to more accurately predict trajectories of agents based on contextual information describing agents in an environment.

An improved approach in accordance with the present technology overcomes the foregoing and other disadvantages associated with conventional approaches. In various embodiments, the vehicle can determine a context for an agent or group of agents. Based on the context, a trajectory prediction algorithm suitable for the context can be selected. Contexts can be represented with various attributes and associated values of the attributes. The attribute values can be extracted from information about an agent from sensor data (e.g., perception of a vehicle) and, optionally, from a semantic map and localization data. Some attributes can be associated with agents. For example, an attribute can indicate that a vehicle is stopped, parked, moving at a certain speed, decelerating, blinking left turn signal, etc. Some attributes can be associated with an expected action of an agent, such as the agent should yield, is crossing, is making a U-turn, is cutting in, is cutting out, etc. Some attributes can be associated with position of an agent, such as in lane, at an intersection, at a stop sign, etc. Some attributes of an agent can be relative to another agent, such as a direction relative to the agent or lane position relative to the agent. Some attributes can be an enumeration, such as blinker state of left, right, or off, and some attributes can be numeric, such as speed or acceleration. Many variations are possible. A context can be a collection of one or more agents and associated attribute values. Accordingly, agents and associated attribute values can provide a context. Performance of various trajectory prediction algorithms can be evaluated for agents of a context. Based on performance of the trajectory algorithms with respect to the context, the context can be associated with a trajectory prediction algorithm that provides a threshold prediction performance. Similar contexts to which the trajectory prediction algorithm provides threshold prediction performance can be mapped together into a cluster. When a new context is identified to be similar to other contexts in the cluster, the trajectory prediction algorithm associated with the cluster can be applied to the new context to predict trajectories of one or more agents.

In general, example trajectory algorithms can include various physics-based trajectory prediction algorithms, ballistic trajectory prediction algorithms, linear trajectory prediction algorithms, and machine learning trajectory prediction algorithms. Each of the different trajectory prediction algorithms can be associated with different properties. In some embodiments, these algorithm properties can also be considered by the vehicle when selecting a trajectory prediction algorithm to predict an agent's trajectory. For example, a first trajectory prediction algorithm may require a lesser amount of time to compute a trajectory for a given object than a second trajectory prediction algorithm. However, the second trajectory prediction algorithm may more accurately predict a trajectory for the object than the first trajectory prediction algorithm. In this example, the vehicle may select the first trajectory prediction to predict the object's trajectory when time is a factor and the second trajectory prediction to predict the object's trajectory when time is not a factor. As a result, the improved approach permits the vehicle to more efficiently and accurately predict agent trajectories and navigate environments more effectively and safely.

For example, FIG. 1B depicts a scenario similar to the one depicted in FIG. 1A. In the example of FIG. 1B, a vehicle 154, which implements the improved approach, can select from a variety of trajectory prediction algorithms to use for predicting trajectories for agents present in an environment 150 which is similar to the example environment 100 in FIG. 1A. In this example, the vehicle 154 can detect the presence of an incoming vehicle 156, an outgoing vehicle 164, and a bicyclist 160. The vehicle 154 can then determine various attributes and values of the attributes for the incoming vehicle 156 based on sensor data captured by sensors of the vehicle 154 and, optionally, based on semantic map data available to the vehicle 154 and localization data of the vehicle 154. The attribute values can, collectively, describe a context associated with the incoming vehicle 156. An example attribute of the incoming vehicle 156 can identify a lane in which the vehicle 156 is located. Other example attributes can indicate a velocity, acceleration, and direction of the vehicle 156. Further, the vehicle 154 can determine attribute values associated with the bicyclist 160. In this example, the attribute values can indicate that the bicyclist 160 is at a complete stop and is facing the intersection 152. The attribute values can, collectively, describe a context associated with the bicyclist 160. The attributes associated with the bicyclist 160 may be different from the attributes associated with the vehicle 154 or the vehicle 164. For example, the context can include the bicyclist 160 only or both the bicyclist 160 and the vehicle 154. Here, a first context can be associated with the bicyclist 160, a second context can be associated with the bicyclist 160 and the vehicle 154, and a third context can be associated with all agents 154, 156, 160, 164. The vehicle 154 may select a first trajectory prediction algorithm for the vehicle 156 and a second trajectory prediction algorithm for the bicyclist 160 based on performances of the trajectory prediction algorithms for the first and second contexts. Regarding the contexts, the vehicle 154 can determine, from its sensors, that the traffic light 158 is out of service. The vehicle 154 can determine from a semantic map and localization data that the vehicle 154 is approaching a four-way stop intersection. Further, the vehicle 154 can determine various agents, including vehicles 156, 164 and the bicyclist 160, in the context and associated attribute values of the agents. For the first context associated with the vehicles 156, 164 at an intersection with out-of-service traffic lights 152, the vehicle 154 can determine a trajectory prediction algorithm that excels at predicting trajectories for vehicles in similar contexts to the first context based on performances of trajectory prediction algorithms for the similar contexts. Here, For example, the vehicle 154 determines that a first trajectory prediction algorithm that reliably predicts agents at a four-way stop intersection is the best candidate for the first context. Based on the first trajectory prediction algorithm, the vehicle 154 determines that it must come to a full stop before the intersection 152. Further, the vehicle 154 can predict that the vehicle 156 will also come to a full stop about the time the vehicle 154 will come to the full stop, and that the vehicle 156 is likely to yield to the vehicle 154 that is on the right side of the vehicle 156 and has the right of way. Thus, the vehicle 154 can determine that it does not need to yield to the vehicle 156. Similarly, the vehicle 154 determines that a second trajectory prediction algorithm that excels at accurately predicting bicyclists in similar contexts is the best candidate for the context associated with the bicyclist 160. According to the second trajectory prediction algorithm, the vehicle 154 determines that the bicyclist 160 has the right of way and is likely to cross a crosswalk 162. Combining the predictions for the vehicle 156 and the bicyclist 160, the vehicle 154 can determine to not immediately proceed into the intersection 152 in view of the having the right of way over the vehicle 156 but wait extra time to allow the bicyclist 160 time to pass. By permitting the vehicle 154 to intelligently select and apply different types of trajectory prediction algorithms based on detected agents and their associated attribute values, the improved approach helps produce more accurate trajectory predictions for the agents. Further, by permitting the vehicle 154 to also select between different trajectory prediction algorithms based on their own algorithm-specific properties (e.g., computation time, prediction reliability, prediction accuracy, etc.), the improved approach provides an improvement in the functioning of computing systems that navigate the vehicle. More details discussing the present technology are provided below.

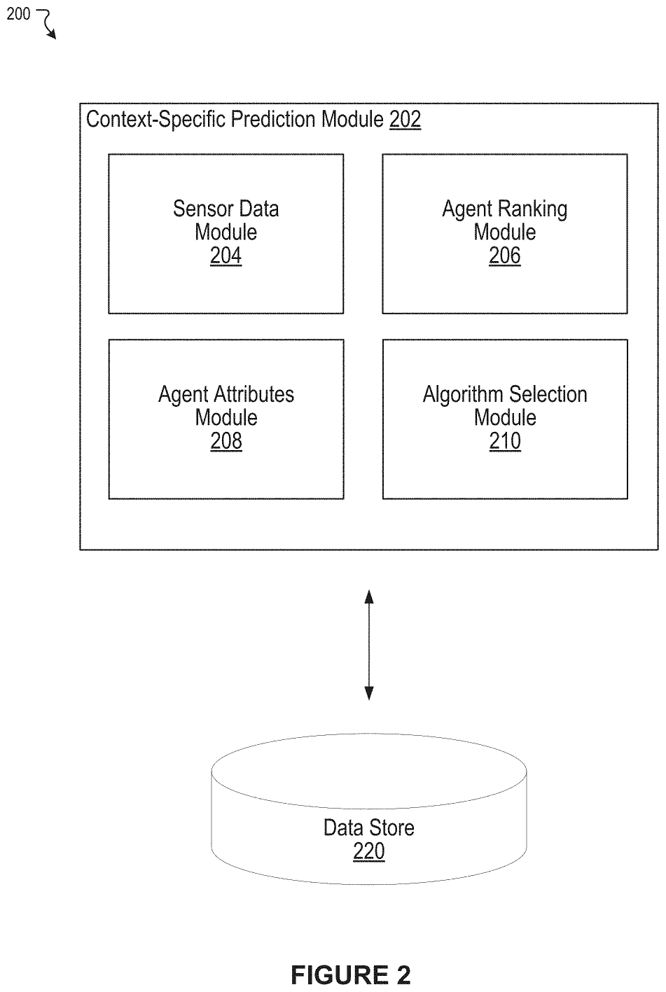

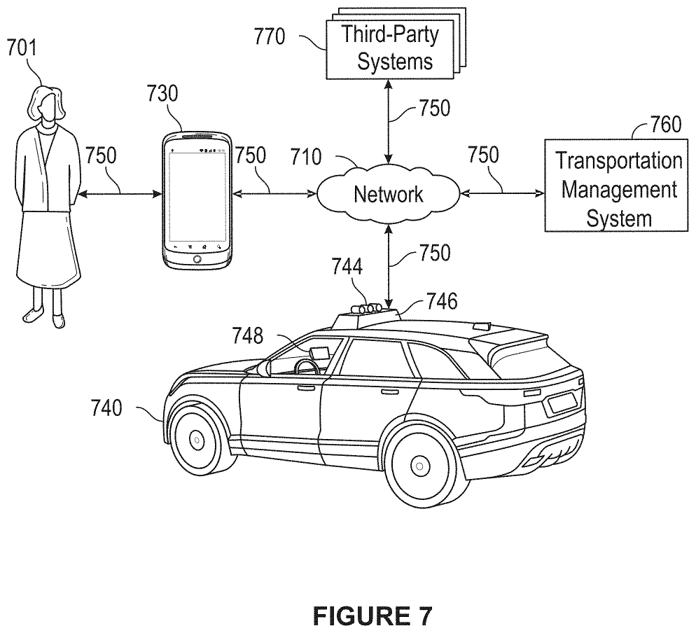

FIG. 2 illustrates an example system 200 including an example context-specific prediction module 202, according to an embodiment of the present technology. As illustrated with the example system 200, the context-specific prediction module 202 can be configured to include a sensor data module 204, an agent ranking module 206, an agent attributes module 208, and an algorithm selection module 210. In some instances, the example system 200 can include at least one data store 220. The context-specific prediction module 202 can be configured to communicate and operate with the at least one data store 220. The at least one data store 220 can be configured to store and maintain various types of data. In some embodiments, some or all of the functionality performed by the context-specific prediction module 202 and its sub-modules may be performed by one or more backend computing systems, such as a transportation management system 760 of FIG. 7. In some embodiments, some or all of the functionality performed by the context-specific prediction module 202 and its sub-modules may be performed by one or more computing systems implemented in a vehicle, such as a vehicle 740 of FIG. 7. In some embodiments, some or all data stored in the data store 220 can be stored by the transportation management system 760 of FIG. 7. In some embodiments, some or all data stored in the data store 220 can be stored by the vehicle 740 of FIG. 7. The components (e.g., modules, elements, etc.) shown in this figure and all figures herein are exemplary only, and other implementations may include additional, fewer, integrated, or different components. Some components may not be shown so as not to obscure relevant details.

In various embodiments, the context-specific prediction module 202 can be implemented by a vehicle being driven semi-autonomously or autonomously. While the vehicle navigates an environment, the context-specific prediction module 202 can detect various agents present in the environment based on sensor data captured by sensors of the vehicle. For example, the context-specific prediction module 202 can detect agents such as other vehicles, pedestrians, bicyclists, animals, among other objects, to name some examples. The context-specific prediction module 202 can also determine related attribute values for the detected agents. For example, attribute values for an agent can identify a type of the agent, motion information, location information, among other features that are indicative of agent intent and movement. In some embodiments, the context-specific prediction module 202 can rank agents based on their attribute values to prioritize trajectory determination. For example, based on the ranking, the context-specific prediction module 202 can prioritize trajectory determination for vehicles driving in the environment over pedestrians walking on a sidewalk. In some embodiments, the context-specific prediction module 202 can determine specific trajectory prediction algorithms to use for predicting trajectories of the agents based at least on attribute values associated with the objects. More details discussing the present technology are provided below.

The sensor data module 204 can be configured to access sensor data captured by vehicles. For example, the sensor data may include data captured by one or more sensors including optical cameras, LiDAR, radar, infrared cameras, and ultrasound equipment, to name some examples. The sensor data module 204 can obtain such sensor data, for example, from the data store 220 or directly from sensors associated with a vehicle in real-time or near real-time. The sensor data can include raw data captured by the sensor data module 204 which can be stored in the data store 220. In some instances, the obtained sensor data may have been collected by a fleet of vehicles that offer transportation services. In some embodiments, the sensor data module 204 can determine contextual information for sensor data such as a respective calendar date, day of the week, and time of the day during which the sensor data was captured. Such contextual information may be obtained from an internal clock of a sensor or a computing device, one or more external computing systems (e.g., Network Time Protocol (NTP) servers), or GPS data, to name some examples.

In general, a vehicle can process sensor data to determine various information about itself and its surroundings. For example, the vehicle may determine its position, or “pose”, based on the sensor data. In another example, the vehicle may determine its velocity and acceleration, a direction of one or more wheels of the vehicle, a lane in which the vehicle is located, among other types of information. Additionally, the vehicle may determine various agents present in its surrounding environment and their respective motion information (e.g., position, direction, velocity, acceleration, etc.) based on the sensor data. More details describing the types of sensor data that may be obtained by the sensor data module 204 are provided below in connection with an array of sensors 744 of FIG. 7.

The agent ranking module 206 can be configured to rank (or filter) agents (e.g., agents identified from the sensor data module 204) based on various ranking criteria to generate a ranked list of agents. The ranked list can be used to prioritize trajectory determination for agents ranked higher in the ranked list. Ranking criteria can be based on relevance, such as importance or criticality, of an identified agent. For example, if an agent is within a threshold distance of a vehicle, that agent may be determined to be of higher relevance to the vehicle than an agent that is not within the threshold distance of the vehicle. In some embodiments, agents can be ranked based on various attributes associated with the agents. For example, an agent that has threshold likelihood of interacting with the vehicle can be ranked higher than an agent that does not satisfy the threshold likelihood of interacting with the vehicle. In another example, an agent that is traveling in an opposite direction of the vehicle can be ranked lower than agents traveling in the same direction as the vehicle. By ranking agents for prioritizing trajectory determination, the agent ranking module 206 permits efficient allocation of computational resources to agents that are more likely to impact operation of the vehicle while accounting for any time-based constraints for completing agent trajectory predictions. For example, with respect to FIG. 1B, the agent ranking module 206 can determine that trajectory predictions for the incoming vehicle 156 and the cyclist 160 are a higher priority than a trajectory prediction for an outgoing vehicle 164, which is moving away from the vehicle 154.

The agent attributes module 208 can be configured to determine attributes and values of the attributes for agents detected in an environment. Each of the identified agents can be associated with various attributes and values for the attributes. The agent attributes module 208 can determine the values of the attributes based on various information acquired from various sources. For example, the agent attributes module 208 can determine attribute values by processing sensor data obtained by the sensor data module 204 and semantic map data for determining semantic locations of agents in an environment.

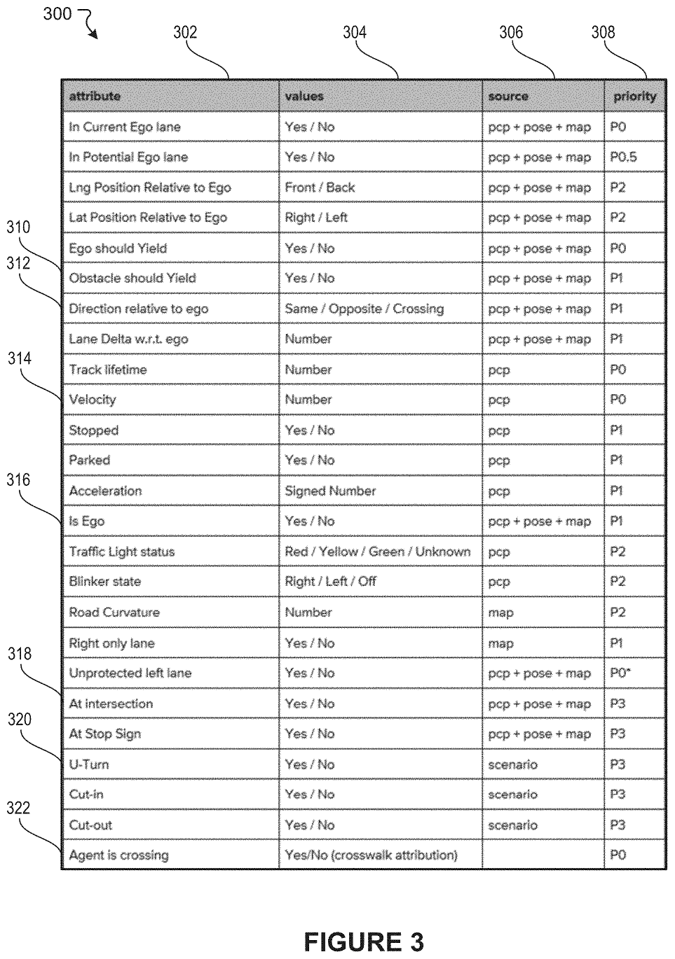

In general, attribute values associated with an agent can describe the agent and a context associated with the agent. For example, an attribute can correspond to an agent type associated with the agent, such as whether the agent is a vehicle, a bicyclist, or a pedestrian, to name some examples. In another example, an attribute can be a property of an agent, such as velocity or acceleration. For example, an agent identified as a pedestrian can be associated with attributes and values of: a “walking velocity” attribute with a value of 0.6 meters/sec (m/s) and a “direction” attribute with a value indicating the pedestrian is traveling north. In another example, an attribute can be a status or state associated with an agent, such as whether the agent is stopped or parked. In further example, an attribute can be related to internalized surrounding information for the agent, such as whether the agent is at a traffic light or a four-way stop intersection. In yet another example, an attribute can describe scenarios being experienced (or expected to be experienced) by an agent, such as whether the agent is expected to make a U-turn maneuver or a right turn. Additional examples of attributes that can be used to describe agents are provided below in reference to FIG. 3.

The algorithm selection module 210 can be configured to select a trajectory prediction algorithm, from a plurality of trajectory prediction algorithms, to predict a trajectory for an agent. The selection of a trajectory prediction algorithm can be based on a context associated with the agent as indicated by the agent's attribute values. As mentioned, a one-size-fits-all algorithm may not provide accurate trajectory predictions for all agents in various contexts. For example, a trajectory prediction algorithm may be better suited for quickly predicting linear trajectories. However, some agents may require a more sophisticated trajectory prediction algorithm to predict their complex non-linear trajectories. For example, a vehicle blinking a right turn signal and decelerating while at a rightmost lane is more likely to make a right turn at an intersection than another vehicle blinking a right turn signal at a leftmost lane and maintaining velocity. Furthermore, some trajectory prediction algorithms may better predict trajectories for certain types of agents with a certain set of attribute-values indicating a certain context.

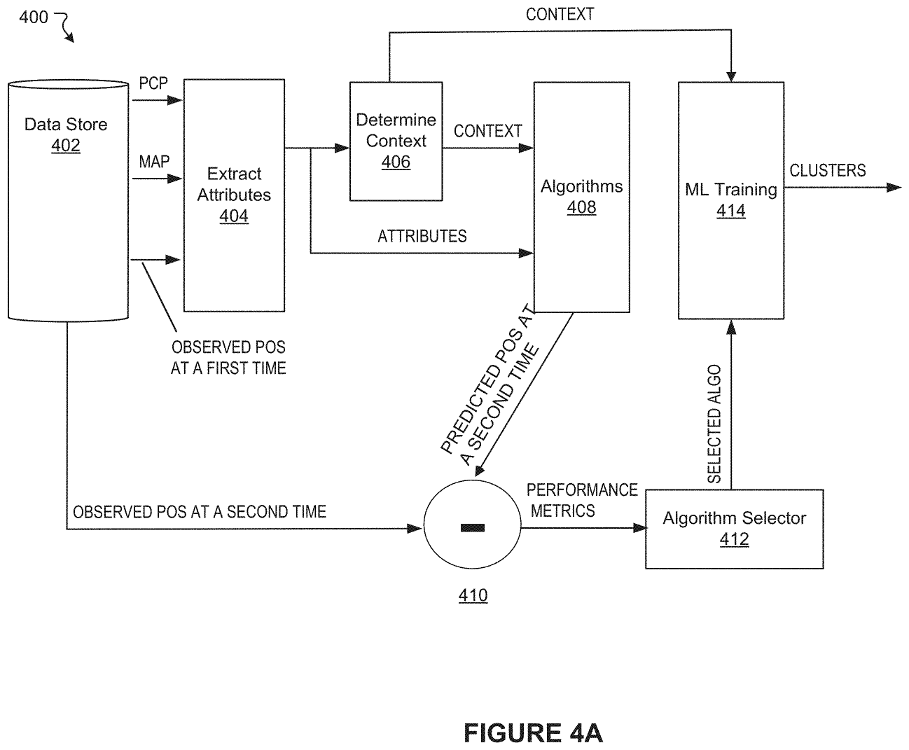

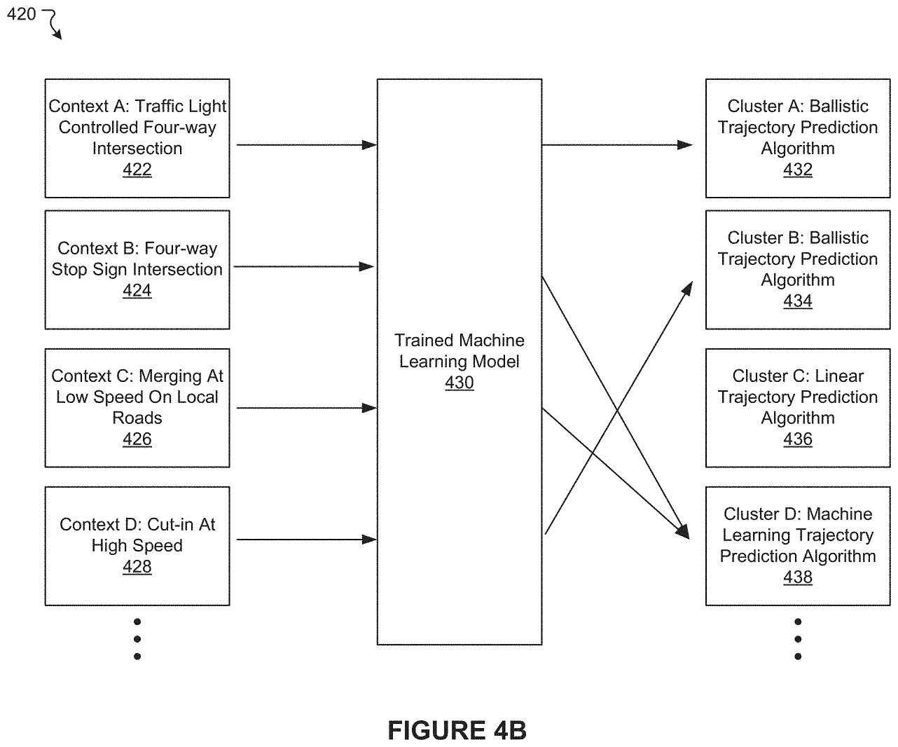

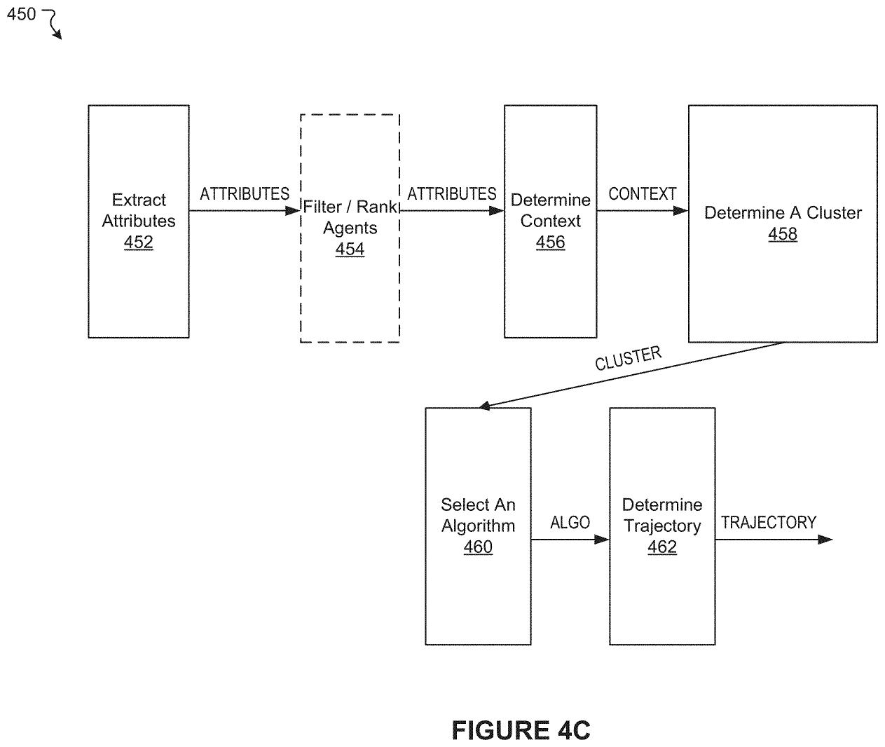

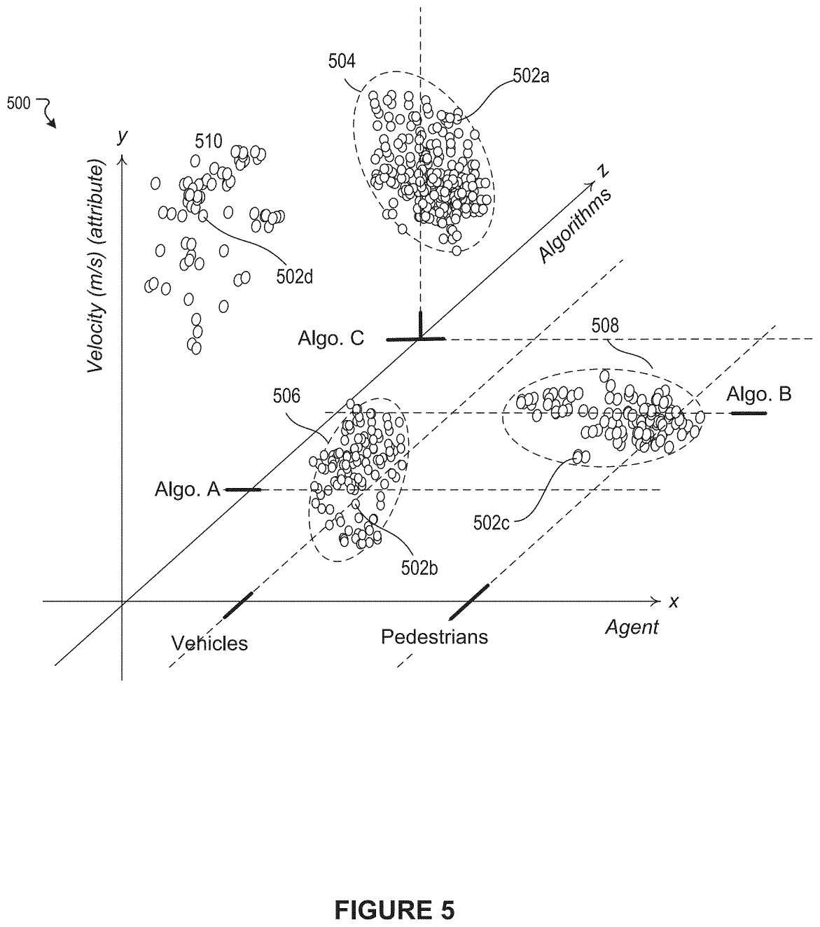

The algorithm selection module 210 can determine and apply trajectory prediction algorithms that are particularly suited for agents based on their contexts. The algorithm selection module 210 can apply various approaches to determine the trajectory prediction algorithms. For example, the algorithm selection module 210 can apply a machine learning approach for selecting trajectory prediction algorithms as described below in reference to FIGS. 4A, 4B, and 4C. The machine learning approach can train a model that relates contexts and trajectory prediction algorithms. In some embodiments, the machine learning approach can additionally provide various performance metrics, such as computing time (e.g., processing time), accuracy, reliability, etc., to train the model. In another example, the algorithm selection module 210 can apply a clustering approach for selecting trajectory prediction algorithms as described below in reference to FIG. 5.

FIG. 3 illustrates example attributes 300 that can be associated with an agent, according to an embodiment of the present technology. Each attribute may include an attribute description 302, an associated value 304, one or more sources 306 from which the attribute value is determined, and/or a priority associated with the attribute 308. As shown, one example attribute 310 can indicate whether an agent should yield. Another example attribute 312 can indicate an agent's direction relative to “ego” (or a vehicle that is predicting a trajectory of the agent). The “Direction relative to Ego” attribute 312 may be associated with a value, which can be one of the values in an enumeration of “Same”, “Opposite”, or “Crossing.” Further, the “Direction relative to Ego” attribute 312 value may be determined from sources including perception data (“pcp”) describing surroundings of the ego vehicle, position data (“pos”) describing positions of the agent and the ego vehicle, and map data (“map”) describing geographic and semantic locations of the agent and ego vehicle. As illustrated, each attribute may be associated with a priority, which can be taken into account in determining a ranking of an associated agent as further described with respect to FIGS. 4A, 4B, and 4C.

FIG. 3 shows another example attribute 314 corresponding to velocity. The “Velocity” attribute 314 can have an associated value that is a number, such as 0.3 m/s, 2.0 m/s, or 8.1 m/s, or the like. The associated value may be determined based on perception data, for example. Another example attribute is an “Is Ego” attribute 316 which can be used to identify an ego vehicle. Yet another example attribute is an “At Intersection” attribute 318, which can describe a relative position of the agent with respect to an intersection. Still yet another example attribute is “U-Turn” attribute 320, which indicates whether the agent is attempting (or is expected to attempt) a U-turn maneuver. Still yet another example attribute is an “Agent is crossing” attribute 322, which indicates whether the agent is crossing a crosswalk. The list of attributes provided in the example attributes 300 is for illustrative purposes and, naturally, myriad other agent attributes can be determined and used for purposes of selecting and applying trajectory prediction algorithms. As discussed previously, one or more agents and their associated attributes and values of the attributes can represent a context.

FIG. 4A illustrates an example diagram 400 illustrating a machine learning approach for training a model to select a trajectory prediction algorithm based on context, according to an embodiment of the present technology. The example diagram 400 illustrates a training phase. The training phase can be performed offline by a computing system. The training phase can include obtaining sensor data collected by a fleet of vehicles, identifying agents from the sensor data, determining various respective attribute values that reflect one or more contexts for the identified agents, and determining trajectory prediction algorithms that are best suited to predict trajectories for the agents based on the one or more contexts and, optionally, other performance criteria (e.g., computation time, prediction accuracy, etc.). More details follow below.

At block 404, various information associated with agents can be extracted from a data store 402 of sensor data collected by a fleet of vehicles. The various information may include perception-related information (PCP in the diagram 400), map-related information (MAP in the diagram 400), and position-related information (OBSERVED POS AT A FIRST TIME AND OBSERVED POS AT A SECOND TIME in the diagram 400). The perception-related information can relate to a contextual understanding of a surrounding environment that an AV determines based on sensor data. For example, the perception-related information may provide detected road signs, agent identifications, agent categorizations, agent locations, agent velocities, agent accelerations, agent intentions, etc. The map-related information can relate to map elements or structural elements of the surrounding environment that the AV determines, for example, from map data. For example, the map data can be semantic map data. Additionally, the map data can include information specific to the surrounding environment, such as hazard information. The position-related information can relate to a localization of the AV with a position and an orientation in a geographic region based on the sensor data (e.g., a GPS), map data, or past and current vehicle motion (e.g., location, velocity, acceleration, etc.), The various information may be acquired from sensor data captured by vehicles navigating their surroundings. The sensor data can provide ground truth data indicating actual trajectories taken by agents detected by the vehicles. These actual trajectories can be evaluated with respect to simulated trajectories predicted by various trajectory prediction algorithms to determine which trajectory prediction algorithms predicted the most accurate trajectories for the agents, for example, based on their corresponding attribute values. A detected agent and its corresponding attribute values can thus be associated with a trajectory prediction algorithm that was determined to most accurately predict a trajectory of the agent based on its corresponding attribute values.

Information describing the extracted agents, attributes, and values of the attributes can be stored in a data store 402. The data store 402 may further store and maintain the sensor data from which the information was determined.

At block 406, a context can be determined for agents based on attributes and values of the attributes. The context can comprise the attribute values. Conversely, the attribute values, as a collection, can represent a context.

At block 408, the context can be provided to a plurality of trajectory prediction algorithms. In some embodiments, attribute values representing the context can be provided to the plurality of trajectory prediction algorithms. The plurality of trajectory prediction algorithms are applied to the context to determine predicted trajectories for agents in the context. From the predicted trajectories, predicted positions of the agents at a future time can be determined. For example, each trajectory prediction algorithm may receive a set of attributes constituting a context associated with an agent at t=0, and predict a trajectory that indicates a position of the agent in the future at t=3.

At block 410, the predicted positions of the agents as predicted by the plurality of trajectory prediction algorithms are evaluated against observed positions of the agents at the future time in ground truth data extracted from the data store 402. Continuing with the above example, ground truth data associated with the agent at t=3 can be obtained, for example, from the data store 402 to determine an actual position of the agent at t=3 (e.g., raw data associated with the agent at t=3). Then, the predicted position of the agent at t=3 can be evaluated against the actual position of the agent at t=3 to determine how accurate a particular trajectory prediction algorithm predicts a trajectory for the agent. The discrepancies between the predicted positions and the observed positions of the agents at the future time can provide performance metrics of the plurality of trajectory prediction algorithms. The performance metrics can be measured with various methodologies, such as absolute position difference, L2 loss, etc. Further, the performance metrics can measure computing times, accuracies, reliabilities, precisions, or other metrics of the plurality of trajectory prediction algorithms for the context.

At block 412, based on the performance metrics, one or more trajectory prediction algorithms can be selected to be associated with the context. The selection of the trajectory prediction algorithm can be based on the performance metrics satisfying performance criteria. For example, the most accurate trajectory prediction algorithm can be selected to be associated with the context. As another example, the fastest computing trajectory prediction algorithm can be selected to be associated with the context. As yet another example, a trajectory prediction algorithm that provides a desirable compromise between accuracy and computing time can be selected. Other variations are possible.

At block 414, the context and the selected trajectory prediction algorithm can be used to train machine learning models that provide a mapping of contexts and trajectory prediction algorithms. One example approach for structuring training data for the machine learning model is as follows:

[Agentᵢ, Attribute₁, Attribute₂, . . . , Attributeₙ| Algorithm], where Agentᵢ corresponds to an agent, Attribute₁˜Attributeₙ correspond to attribute values that represent a context associated with the agent, and Algorithm corresponds to a trajectory prediction algorithm to be used for predicting trajectories of an agent sharing similar context. Optionally, performance metrics can be additionally provided in the training data such that a context is associated with a trajectory prediction algorithm and specific performance metrics provided to the training data. In some embodiments, the training data can be structured to represent a context based on one or more agents and their respective attributes. For example, a context can include a cyclist and a vehicle, where the cyclist and the vehicle are associated with respective sets of attributes. After the training, contexts associated with trajectory prediction algorithms can be clustered. More details on clustering contexts are provided in reference to FIG. 5.

FIG. 4B illustrates an example diagram 420 illustrating a trained machine learning model 430 that associates contexts with clusters which, in turn, are associated with trajectory prediction algorithms. For example, as described with respect to FIG. 4A, the trained machine learning model 430 is trained based on training data that associates contexts with trajectory prediction algorithms based on performance metrics of the trajectory prediction algorithms on the contexts. For example, a particular trajectory prediction algorithm can be associated with a particular context because the particular trajectory prediction algorithm better predicts trajectories for the particular context than another trajectory prediction algorithm. Once trained, the trained model can receive various contexts as input. The example diagram 420 illustrates four such example contexts provided as input, but there is no limit to the number or types of contexts that can be provided as input. A first context 422 may be associated with or represent a traffic light controlled four-way intersection. A second context 424 may be associated with or represent a four-way stop sign intersection. A third context 426 may be associated with or represent merging at low speed on local roads. A fourth context 428 may be associated with or represent cut-in at high speed. Based on a context provided as an input, the trained machine learning model 430 can determine a cluster associated with the context. The trained machine learning model 430 can provide, as output, a cluster for an inputted context. As illustrated, the trained machine learning model 430 can provide many-to-one relationship between the contexts and the clusters. For example, the example diagram 420 illustrates a first cluster 432 for the first context 422, a second cluster 434 for the fourth context 428, a fourth cluster 438 for the second context 424 and the third context 426. The remaining third cluster 436 can be associated with a context other than the first context 422, the second context 424, the third context 426, and the fourth context 428. In turn, each cluster can be associated with a trajectory prediction algorithm, such as a ballistic trajectory prediction algorithm, a linear trajectory prediction algorithm, a machine learning trajectory prediction algorithm, etc.

FIG. 4C illustrates an example diagram 450 illustrating inferring a trajectory prediction algorithm based on a context, according to an embodiment of the present technology. The example diagram 450 illustrates an inference phase. The inference phase can be performed online by a vehicle navigating an environment in real-time (or near real-time). The inference phase can include collecting sensor data describing the environment, identifying agents from the sensor data, and determining various attributes that collectively determine one or more contexts for the agents based on their respective associated attributes. Based on the associations of trajectory prediction algorithms to clusters as determined in the training phase, the inference phase can select a trajectory prediction algorithm to apply to the determined context of an identified agent. More details follow.

At block 452, a vehicle can identify agents present in its surrounding environment and extract their corresponding attributes values.

At block 454, optionally, the vehicle can filter the identified agents based on various criteria. For example, if an agent is a threshold distance away from the vehicle (e.g., > or =100 m, etc.), then the agent may be considered not sufficiently relevant and thus a trajectory need not be determined for the agent. Similarly, the vehicle can filter out any stopped vehicles that are not located on a drivable surface (e.g., vehicles on driveways, garages, etc.). In some embodiments, the filtering can be based on agent attributes or values of the agent attributes. The vehicle can also rank the identified agents. For example, relevance scores can be determined for the identified agents and be used to rank the agents. The relevance scores may indicate urgency of predicting trajectories for the identified agents or importance of accurately predicting the trajectories. The relevance scores may be based on agent attributes, such as a distance of an identified agent from the vehicle or a velocity of the identified agent. The filtering and the ranking of the agents can be performed simultaneously, in tandem, and in any order. For example, the identified agents can be ranked and filtered to retain a highest ranking list of agents (e.g., top 5 agents, top 10 agents, etc.). In some embodiments, the filtering and the ranking can be based on available computing resources on the AV, an amount of time available to complete trajectory predictions, or both. In another embodiment, a ranked list of the agents can be provided without performing any filtering.

At block 456, a context can be determined for agents based on attributes and values of the attributes. The context can comprise the attribute values. Conversely, the attribute values, as a collection, can represent a context.

At block 458, a cluster containing similar contexts to the context can be determined for the context. In some embodiments, the determination of the cluster can be assisted by a trained machine learning model, such as the model trained at block 414 of FIG. 4A.

At block 460, a trajectory prediction algorithm is selected for the context. In some embodiments, a trained machine learning model can assist selection of a trajectory prediction algorithm for the context. The trained machine learning model can be a machine learning model trained during the training phase at block 414 of FIG. 4A. For example, the trained machine learning model can receive a set of features describing an agent and its attributes as input collectively representing a context. The trained machine learning model can evaluate the inputted features to select a trajectory prediction algorithm for the context. In some embodiments, the trained machine learning model can provide confidence scores associated with one or more potential trajectory prediction algorithms that can be used to predict a trajectory of the agent. In this example, a trajectory prediction algorithm that has the best confidence score can be selected as the trajectory prediction algorithm to be used to predict a trajectory of the agent. In some embodiments, the trained machine learning model can combine the blocks 458 and 460, thus taking in as an input a context and providing an output of a selected trajectory prediction algorithm.

At block 462, trajectories for the agents can be determined using the selected trajectory prediction algorithms.

In some embodiments, blocks 454, 456, 458, 460, and 462 can work in conjunction to optimize trajectory predictions. For example, assume a vehicle identifies five agents in a context and ranks the five agents. Further assume that the vehicle has a time constraint of 100 milliseconds for completing trajectory predictions. In this example, the vehicle may begin performing trajectory predictions with the highest priority agent. A first trajectory prediction algorithm may require 45 milliseconds to predict a trajectory for first-ranked agent. A second trajectory prediction algorithm may take 5 ms to predict a trajectory for a second-ranked agent, which increases a total prediction time from 45 milliseconds to 50 milliseconds. Next, a third trajectory prediction algorithm may take 40 ms to predict a trajectory for a third-ranked agent, which increases the total prediction time to 90 ms. In an embodiment, the vehicle may determine that the allocated time of 100 milliseconds is almost exhausted and select the second trajectory prediction algorithm for predicting trajectories of a fourth-ranked agent and a fifth-ranked agent, which allows the vehicle enough time to predict trajectories for all five objects within the 100 millisecond timeframe. In another embodiment, the vehicle may continue to predict a trajectory for the fourth-ranked agent with a fourth trajectory prediction algorithm that requires 15 milliseconds to complete, which increases the total prediction time to 105 milliseconds. In such embodiments, the vehicle may determine that the 100 millisecond time frame is exhausted and thus not determine a trajectory for the fifth-ranked agent. Many variations are possible.

FIG. 5 illustrates an example diagram 500, according to an embodiment of the present technology. As mentioned, various attributes and their associated values can constitute a context. The example diagram 500 provides two example attributes (agent type and velocity) respectively represented by the x-axis and the y-axis. While only two attributes are illustrated in FIG. 5 for ease of illustration, additional attributes may be associated with their own respective axes in a high-dimensional feature space representing different contexts. Each context can be plotted in the high-dimensional space based on associated attributes and their values. Accordingly, contexts (e.g., 502a-d) and clusters (504, 506, 508) of the contexts can be represented in a high-dimensional space with tens, hundreds, or even thousands of axes corresponding to attributes. In the example diagram 500, a z-axis represents different trajectory prediction algorithms that can be applied with each cluster being associated with a trajectory prediction algorithm that is best suited to predict trajectories for the contexts represented by the cluster.

In some embodiments, clusters can be determined for similar contexts based on a clustering technique. Any suitable conventional clustering technique can be used. Once clusters are determined, various trajectory prediction algorithms can be applied to the clusters to determine confidence scores associated with the trajectory prediction algorithms with respect to the clusters. Each cluster can be associated with a trajectory prediction algorithm that best predicts trajectories for contexts represented by the cluster.

In the example diagram 500, three clusters are associated with their own trajectory prediction algorithms. A cluster 504 of vehicles with a velocity that falls within a first pre-defined range is associated with algorithm C because algorithm C predicts trajectories for similar contexts in the cluster 504 better than algorithm A and algorithm B (e.g., performance metrics of the algorithm C are superior to the corresponding performance metrics of algorithms A and B). A cluster 506 of vehicles with a velocity that falls within a second pre-defined range is associated with the algorithm A, because algorithm A predicts trajectories for contexts represented by the cluster 506 better than algorithm B or algorithm C. A cluster 508 of pedestrians with a velocity that falls within a third pre-defined range is associated with algorithm B, because algorithm B predicts trajectories for the contexts represented by the cluster 508 better than algorithm A or algorithm C. In some cases, it can be determined that none of the trajectory prediction algorithms accurately predict trajectories for some contexts 510, such as a context 502d. The outlier contexts 510 can indicate a need to tune an existing trajectory prediction algorithm or, in some cases, introduce a new trajectory prediction algorithm to more accurately predict trajectories for the outlier contexts 510. For example, the outlier contexts 510 can be absent in the clusters 504, 506, 508 because none of the trajectory prediction algorithms provided satisfactory performance metrics, which can indicate that the outlier contexts 510 are not similar to contexts in one of the clusters 504, 506, 508. The new trajectory prediction algorithm can be applied to the outlier contexts 510 and evaluated for its performance metrics on the outlier contexts 510. The new trajectory prediction algorithm can be iteratively tuned and evaluated until the outlier contexts 510 are sufficiently closely mapped on the high-dimensional feature space. Then the outlier contexts 510 can be clustered in a new cluster that is associated with the new trajectory prediction algorithm. Accordingly, the present technologies are advantageous in understanding the strengths and weaknesses of each trajectory prediction algorithm in association with various contexts and identifying outlier contexts 510 so that remedial efforts can be undertaken. Many variations are possible.

In some embodiments, trajectory prediction algorithms can be associated with clusters manually. For example, a human may evaluate and associate the cluster 506 with a particular trajectory prediction algorithm. In some embodiments, trajectory prediction algorithms associated with clusters can be implemented as code-based logic, such as instructing a vehicle to use the particular trajectory prediction algorithm A for all vehicles moving with a speed less than 1 m/s. Similarly, another example of code-based logic can instruct a vehicle to use algorithm C for all vehicles moving with a speed greater than 3 m/s. When the code-based logic results in overlapping associations, the overlaps can be addressed with a priority-based logic where a trajectory prediction algorithm with higher priority addresses a context associated with the overlapping association. In another approach, code-based logic can be carefully crafted to enforce mutual exclusion of the associations. For example, the code-based logic can introduce additional conditional clauses to split the overlapping associations into separate associations. Continuing with the above example code-based logic that instructs the vehicle to use algorithm C for all vehicles moving with a speed greater than 3 m/s, an additional conditional clause can be added to the code-based logic to specifically address all trucks moving with a speed greater than 3 m/s with algorithm D (e.g., “if a vehicle is moving with a speed greater than 3 m/s, check for a type of the vehicle; if the vehicle is a truck, use algorithm D; else use algorithm C.”). In yet another approach, multiple trajectory prediction algorithms can process an agent in parallel to predict respective trajectories and provide confidence scores for the respective trajectories. The algorithm selection module 210 can, based on confidence scores provided by the trajectory prediction algorithms, select a trajectory prediction algorithm with the highest confidence score. In some embodiments, for contexts that are not sufficiently strongly associated with a trajectory prediction algorithm (e.g., none of the confidence scores provided with available trajectory prediction algorithms are satisfactory) or for agents that were not processed within a reasonable time, the algorithm selection module 210 may provide a default, fallback trajectory prediction algorithm.

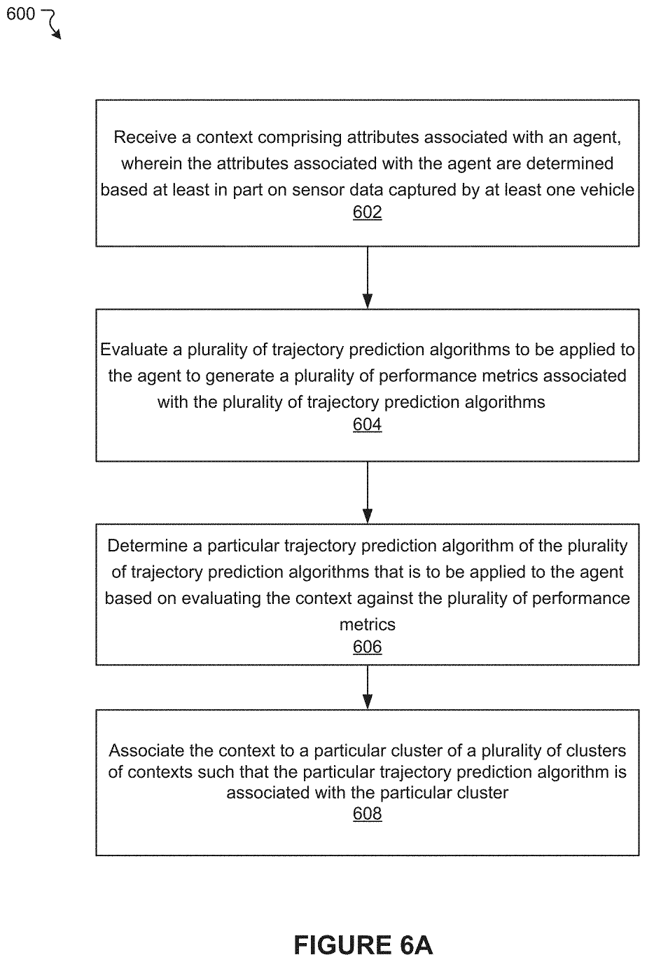

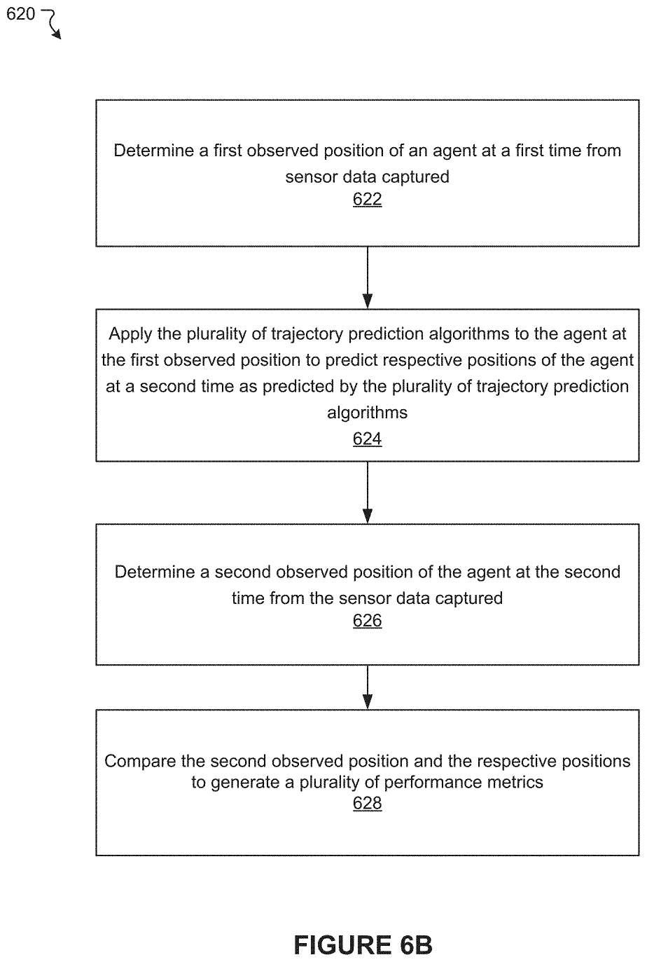

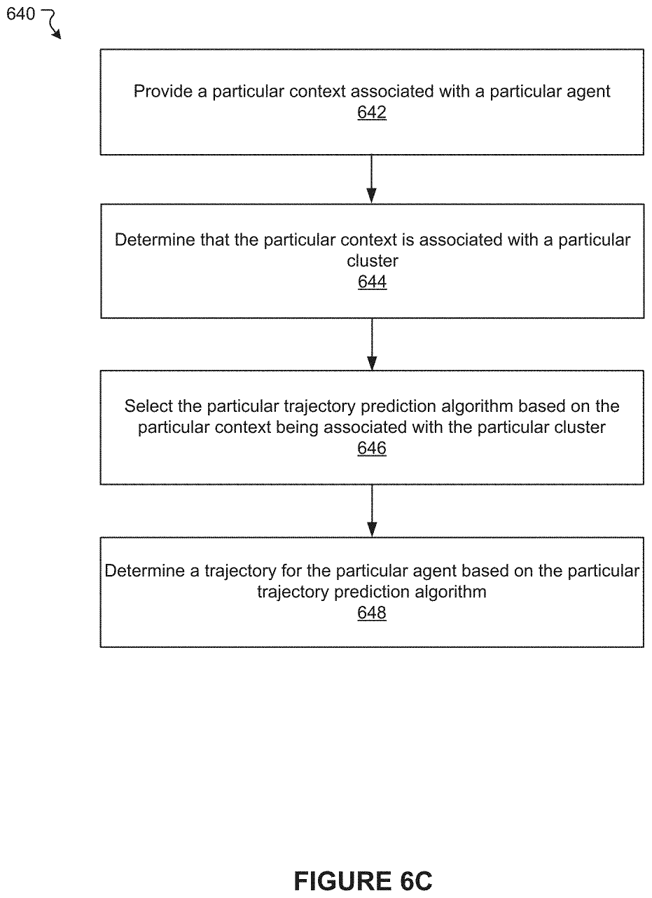

FIG. 6A illustrates an example method 600, according to an embodiment of the present technology. At block 602, a context comprising attributes associated with an agent can be received. The attributes associated with the agent can be determined based at least in part on sensor data captured by at least one vehicle. At block 604, a plurality of trajectory prediction algorithms to be applied to the agent can be evaluated on first agent to generate a plurality of performance metrics associated with the plurality of trajectory prediction algorithms. At block 606, a particular trajectory prediction algorithm of the plurality of trajectory prediction algorithms that is to be applied to the agent can be determined based on evaluating the context against the plurality of performance metrics. At block 608, the context can be associated with a particular cluster of a plurality of clusters of contexts such that the particular trajectory prediction algorithm is associated with the particular cluster.

FIG. 6B illustrates an example method 620, according to an embodiment of the present technology. At block 622, a first observed position of an agent at a first time can be determined from sensor data captured. At block 624, a plurality of trajectory prediction algorithms can be applied to the agent at the first observed position to predict respective positions of the agent at a second time as predicted by the plurality of trajectory prediction algorithms. At block 626, a second observed position of the agent at the second time can be determined from the sensor data captured. At block 628, the second observed position and the respective positions can be compared to generate a plurality of performance metrics.

FIG. 6C illustrates an example method 640, according to an embodiment of the present technology. At block 642, a particular context associated with a particular agent can be provided. At block 644, that the particular context is associated with a particular cluster can be determined. At block 646, the particular trajectory prediction algorithm can be selected based on the particular context being associated with the particular cluster. At block 648, a trajectory for the particular agent can be determined based on the particular trajectory prediction algorithm.

FIG. 7 illustrates an example block diagram of a transportation management environment for matching ride requestors with vehicles. In particular embodiments, the environment may include various computing entities, such as a user computing device 730 of a user 701 (e.g., a ride provider or requestor), a transportation management system 760, a vehicle 740, and one or more third-party systems 770. The vehicle 740 can be autonomous, semi-autonomous, or manually drivable. The computing entities may be communicatively connected over any suitable network 710. As an example and not by way of limitation, one or more portions of network 710 may include an ad hoc network, an extranet, a virtual private network (VPN), a local area network (LAN), a wireless LAN (WLAN), a wide area network (WAN), a wireless WAN (WWAN), a metropolitan area network (MAN), a portion of the Internet, a portion of Public Switched Telephone Network (PSTN), a cellular network, or a combination of any of the above. In particular embodiments, any suitable network arrangement and protocol enabling the computing entities to communicate with each other may be used. Although FIG. 7 illustrates a single user device 730, a single transportation management system 760, a single vehicle 740, a plurality of third-party systems 770, and a single network 710, this disclosure contemplates any suitable number of each of these entities. As an example and not by way of limitation, the network environment may include multiple users 701, user devices 730, transportation management systems 760, vehicles 740, third-party systems 770, and networks 710. In some embodiments, some or all modules of the context-specific prediction module 202 may be implemented by one or more computing systems of the transportation management system 760. In some embodiments, some or all modules of the context-specific prediction module 202 may be implemented by one or more computing systems in the vehicle 740.

The user device 730, transportation management system 760, vehicle 740, and third-party system 770 may be communicatively connected or co-located with each other in whole or in part. These computing entities may communicate via different transmission technologies and network types. For example, the user device 730 and the vehicle 740 may communicate with each other via a cable or short-range wireless communication (e.g., Bluetooth, NFC, WI-FI, etc.), and together they may be connected to the Internet via a cellular network that is accessible to either one of the devices (e.g., the user device 730 may be a smartphone with LTE connection). The transportation management system 760 and third-party system 770, on the other hand, may be connected to the Internet via their respective LAN/WLAN networks and Internet Service Providers (ISP). FIG. 7 illustrates transmission links 750 that connect user device 730, vehicle 740, transportation management system 760, and third-party system 770 to communication network 710. This disclosure contemplates any suitable transmission links 750, including, e.g., wire connections (e.g., USB, Lightning, Digital Subscriber Line (DSL) or Data Over Cable Service Interface Specification (DOCSIS)), wireless connections (e.g., WI-FI, WiMAX, cellular, satellite, NFC, Bluetooth), optical connections (e.g., Synchronous Optical Networking (SONET), Synchronous Digital Hierarchy (SDH)), any other wireless communication technologies, and any combination thereof. In particular embodiments, one or more links 750 may connect to one or more networks 710, which may include in part, e.g., ad-hoc network, the Intranet, extranet, VPN, LAN, WLAN, WAN, WWAN, MAN, PSTN, a cellular network, a satellite network, or any combination thereof. The computing entities need not necessarily use the same type of transmission link 750. For example, the user device 730 may communicate with the transportation management system via a cellular network and the Internet, but communicate with the vehicle 740 via Bluetooth or a physical wire connection.

In particular embodiments, the transportation management system 760 may fulfill ride requests for one or more users 701 by dispatching suitable vehicles. The transportation management system 760 may receive any number of ride requests from any number of ride requestors 701. In particular embodiments, a ride request from a ride requestor 701 may include an identifier that identifies the ride requestor in the system 760. The transportation management system 760 may use the identifier to access and store the ride requestor's 701 information, in accordance with the requestor's 701 privacy settings. The ride requestor's 701 information may be stored in one or more data stores (e.g., a relational database system) associated with and accessible to the transportation management system 760. In particular embodiments, ride requestor information may include profile information about a particular ride requestor 701. In particular embodiments, the ride requestor 701 may be associated with one or more categories or types, through which the ride requestor 701 may be associated with aggregate information about certain ride requestors of those categories or types. Ride information may include, for example, preferred pick-up and drop-off locations, driving preferences (e.g., safety comfort level, preferred speed, rates of acceleration/deceleration, safety distance from other vehicles when travelling at various speeds, route, etc.), entertainment preferences and settings (e.g., preferred music genre or playlist, audio volume, display brightness, etc.), temperature settings, whether conversation with the driver is welcomed, frequent destinations, historical riding patterns (e.g., time of day of travel, starting and ending locations, etc.), preferred language, age, gender, or any other suitable information. In particular embodiments, the transportation management system 760 may classify a user 701 based on known information about the user 701 (e.g., using machine-learning classifiers), and use the classification to retrieve relevant aggregate information associated with that class. For example, the system 760 may classify a user 701 as a young adult and retrieve relevant aggregate information associated with young adults, such as the type of music generally preferred by young adults.

Transportation management system 760 may also store and access ride information. Ride information may include locations related to the ride, traffic data, route options, optimal pick-up or drop-off locations for the ride, or any other suitable information associated with a ride. As an example and not by way of limitation, when the transportation management system 760 receives a request to travel from San Francisco International Airport (SFO) to Palo Alto, Calif., the system 760 may access or generate any relevant ride information for this particular ride request. The ride information may include, for example, preferred pick-up locations at SFO; alternate pick-up locations in the event that a pick-up location is incompatible with the ride requestor (e.g., the ride requestor may be disabled and cannot access the pick-up location) or the pick-up location is otherwise unavailable due to construction, traffic congestion, changes in pick-up/drop-off rules, or any other reason; one or more routes to navigate from SFO to Palo Alto; preferred off-ramps for a type of user; or any other suitable information associated with the ride. In particular embodiments, portions of the ride information may be based on historical data associated with historical rides facilitated by the system 760. For example, historical data may include aggregate information generated based on past ride information, which may include any ride information described herein and telemetry data collected by sensors in vehicles and user devices. Historical data may be associated with a particular user (e.g., that particular user's preferences, common routes, etc.), a category/class of users (e.g., based on demographics), and all users of the system 760. For example, historical data specific to a single user may include information about past rides that particular user has taken, including the locations at which the user is picked up and dropped off, music the user likes to listen to, traffic information associated with the rides, time of the day the user most often rides, and any other suitable information specific to the user. As another example, historical data associated with a category/class of users may include, e.g., common or popular ride preferences of users in that category/class, such as teenagers preferring pop music, ride requestors who frequently commute to the financial district may prefer to listen to the news, etc. As yet another example, historical data associated with all users may include general usage trends, such as traffic and ride patterns. Using historical data, the system 760 in particular embodiments may predict and provide ride suggestions in response to a ride request. In particular embodiments, the system 760 may use machine-learning, such as neural networks, regression algorithms, instance-based algorithms (e.g., k-Nearest Neighbor), decision-tree algorithms, Bayesian algorithms, clustering algorithms, association-rule-learning algorithms, deep-learning algorithms, dimensionality-reduction algorithms, ensemble algorithms, and any other suitable machine-learning algorithms known to persons of ordinary skill in the art. The machine-learning models may be trained using any suitable training algorithm, including supervised learning based on labeled training data, unsupervised learning based on unlabeled training data, and semi-supervised learning based on a mixture of labeled and unlabeled training data.

In particular embodiments, transportation management system 760 may include one or more server computers. Each server may be a unitary server or a distributed server spanning multiple computers or multiple datacenters. The servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, transportation management system 760 may include one or more data stores. The data stores may be used to store various types of information, such as ride information, ride requestor information, ride provider information, historical information, third-party information, or any other suitable type of information. In particular embodiments, the information stored in the data stores may be organized according to specific data structures. In particular embodiments, each data store may be a relational, columnar, correlation, or any other suitable type of database system. Although this disclosure describes or illustrates particular types of databases, this disclosure contemplates any suitable types of databases. Particular embodiments may provide interfaces that enable a user device 730 (which may belong to a ride requestor or provider), a transportation management system 760, vehicle system 740, or a third-party system 770 to process, transform, manage, retrieve, modify, add, or delete the information stored in the data store.

In particular embodiments, transportation management system 760 may include an authorization server (or any other suitable component(s)) that allows users 701 to opt-in to or opt-out of having their information and actions logged, recorded, or sensed by transportation management system 760 or shared with other systems (e.g., third-party systems 770). In particular embodiments, a user 701 may opt-in or opt-out by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users 701 of transportation management system 760 through blocking, data hashing, anonymization, or other suitable techniques as appropriate.

In particular embodiments, third-party system 770 may be a network-addressable computing system that may provide HD maps or host GPS maps, customer reviews, music or content, weather information, or any other suitable type of information. Third-party system 770 may generate, store, receive, and send relevant data, such as, for example, map data, customer review data from a customer review website, weather data, or any other suitable type of data. Third-party system 770 may be accessed by the other computing entities of the network environment either directly or via network 710. For example, user device 730 may access the third-party system 770 via network 710, or via transportation management system 760. In the latter case, if credentials are required to access the third-party system 770, the user 701 may provide such information to the transportation management system 760, which may serve as a proxy for accessing content from the third-party system 770.

In particular embodiments, user device 730 may be a mobile computing device such as a smartphone, tablet computer, or laptop computer. User device 730 may include one or more processors (e.g., CPU, GPU), memory, and storage. An operating system and applications may be installed on the user device 730, such as, e.g., a transportation application associated with the transportation management system 760, applications associated with third-party systems 770, and applications associated with the operating system. User device 730 may include functionality for determining its location, direction, or orientation, based on integrated sensors such as GPS, compass, gyroscope, or accelerometer. User device 730 may also include wireless transceivers for wireless communication and may support wireless communication protocols such as Bluetooth, near-field communication (NFC), infrared (IR) communication, WI-FI, and 2G/3G/4G/LTE mobile communication standard. User device 730 may also include one or more cameras, scanners, touchscreens, microphones, speakers, and any other suitable input-output devices.

In particular embodiments, the vehicle 740 may be equipped with an array of sensors 744, a navigation system 746, and a ride-service computing device 748. In particular embodiments, a fleet of vehicles 740 may be managed by the transportation management system 760. The fleet of vehicles 740, in whole or in part, may be owned by the entity associated with the transportation management system 760, or they may be owned by a third-party entity relative to the transportation management system 760. In either case, the transportation management system 760 may control the operations of the vehicles 740, including, e.g., dispatching select vehicles 740 to fulfill ride requests, instructing the vehicles 740 to perform select operations (e.g., head to a service center or charging/fueling station, pull over, stop immediately, self-diagnose, lock/unlock compartments, change music station, change temperature, and any other suitable operations), and instructing the vehicles 740 to enter select operation modes (e.g., operate normally, drive at a reduced speed, drive under the command of human operators, and any other suitable operational modes).

In particular embodiments, the vehicles 740 may receive data from and transmit data to the transportation management system 760 and the third-party system 770. Examples of received data may include, e.g., instructions, new software or software updates, maps, 3D models, trained or untrained machine-learning models, location information (e.g., location of the ride requestor, the vehicle 740 itself, other vehicles 740, and target destinations such as service centers), navigation information, traffic information, weather information, entertainment content (e.g., music, video, and news) ride requestor information, ride information, and any other suitable information. Examples of data transmitted from the vehicle 740 may include, e.g., telemetry and sensor data, determinations/decisions based on such data, vehicle condition or state (e.g., battery/fuel level, tire and brake conditions, sensor condition, speed, odometer, etc.), location, navigation data, passenger inputs (e.g., through a user interface in the vehicle 740, passengers may send/receive data to the transportation management system 760 and third-party system 770), and any other suitable data.

In particular embodiments, vehicles 740 may also communicate with each other, including those managed and not managed by the transportation management system 760. For example, one vehicle 740 may communicate with another vehicle data regarding their respective location, condition, status, sensor reading, and any other suitable information. In particular embodiments, vehicle-to-vehicle communication may take place over direct short-range wireless connection (e.g., WI-FI, Bluetooth, NFC) or over a network (e.g., the Internet or via the transportation management system 760 or third-party system 770), or both.

In particular embodiments, a vehicle 740 may obtain and process sensor/telemetry data. Such data may be captured by any suitable sensors. For example, the vehicle 740 may have a Light Detection and Ranging (LiDAR) sensor array of multiple LiDAR transceivers that are configured to rotate 360°, emitting pulsed laser light and measuring the reflected light from objects surrounding vehicle 740. In particular embodiments, LiDAR transmitting signals may be steered by use of a gated light valve, which may be a MEMs device that directs a light beam using the principle of light diffraction. Such a device may not use a gimbaled mirror to steer light beams in 360° around the vehicle. Rather, the gated light valve may direct the light beam into one of several optical fibers, which may be arranged such that the light beam may be directed to many discrete positions around the vehicle. Thus, data may be captured in 360° around the vehicle, but no rotating parts may be necessary. A LiDAR is an effective sensor for measuring distances to targets, and as such may be used to generate a three-dimensional (3D) model of the external environment of the vehicle 740. As an example and not by way of limitation, the 3D model may represent the external environment including objects such as other cars, curbs, debris, objects, and pedestrians up to a maximum range of the sensor arrangement (e.g., 50, 100, or 200 meters). As another example, the vehicle 740 may have optical cameras pointing in different directions. The cameras may be used for, e.g., recognizing roads, lane markings, street signs, traffic lights, police, other vehicles, and any other visible objects of interest. To enable the vehicle 740 to “see” at night, infrared cameras may be installed. In particular embodiments, the vehicle may be equipped with stereo vision for, e.g., spotting hazards such as pedestrians or tree branches on the road. As another example, the vehicle 740 may have radars for, e.g., detecting other vehicles and hazards afar. Furthermore, the vehicle 740 may have ultrasound equipment for, e.g., parking and agent detection. In addition to sensors enabling the vehicle 740 to detect, measure, and understand the external world around it, the vehicle 740 may further be equipped with sensors for detecting and self-diagnosing the vehicle's own state and condition. For example, the vehicle 740 may have wheel sensors for, e.g., measuring velocity; global positioning system (GPS) for, e.g., determining the vehicle's current geolocation; and inertial measurement units, accelerometers, gyroscopes, and odometer systems for movement or motion detection. While the description of these sensors provides particular examples of utility, one of ordinary skill in the art would appreciate that the utilities of the sensors are not limited to those examples. Further, while an example of a utility may be described with respect to a particular type of sensor, it should be appreciated that the utility may be achieved using any combination of sensors. For example, the vehicle 740 may build a 3D model of its surrounding based on data from its LiDAR, radar, sonar, and cameras, along with a pre-generated map obtained from the transportation management system 760 or the third-party system 770. Although sensors 744 appear in a particular location on the vehicle 740 in FIG. 7, sensors 744 may be located in any suitable location in or on the vehicle 740. Example locations for sensors include the front and rear bumpers, the doors, the front windshield, on the side panel, or any other suitable location.

In particular embodiments, the vehicle 740 may be equipped with a processing unit (e.g., one or more CPUs and GPUs), memory, and storage. The vehicle 740 may thus be equipped to perform a variety of computational and processing tasks, including processing the sensor data, extracting useful information, and operating accordingly. For example, based on images captured by its cameras and a machine-vision model, the vehicle 740 may identify particular types of objects captured by the images, such as pedestrians, other vehicles, lanes, curbs, and any other objects of interest.

In particular embodiments, the vehicle 740 may have a navigation system 746 responsible for safely navigating the vehicle 740. In particular embodiments, the navigation system 746 may take as input any type of sensor data from, e.g., a Global Positioning System (GPS) module, inertial measurement unit (IMU), LiDAR sensors, optical cameras, radio frequency (RF) transceivers, or any other suitable telemetry or sensory mechanisms. The navigation system 746 may also utilize, e.g., map data, traffic data, accident reports, weather reports, instructions, target destinations, and any other suitable information to determine navigation routes and particular driving operations (e.g., slowing down, speeding up, stopping, swerving, etc.). In particular embodiments, the navigation system 746 may use its determinations to control the vehicle 740 to operate in prescribed manners and to guide the vehicle 740 to its destinations without colliding into other objects. Although the physical embodiment of the navigation system 746 (e.g., the processing unit) appears in a particular location on the vehicle 740 in FIG. 7, navigation system 746 may be located in any suitable location in or on the vehicle 740. Example locations for navigation system 746 include inside the cabin or passenger compartment of the vehicle 740, near the engine/battery, near the front seats, rear seats, or in any other suitable location.

In particular embodiments, the vehicle 740 may be equipped with a ride-service computing device 748, which may be a tablet or any other suitable device installed by transportation management system 760 to allow the user to interact with the vehicle 740, transportation management system 760, other users 701, or third-party systems 770. In particular embodiments, installation of ride-service computing device 748 may be accomplished by placing the ride-service computing device 748 inside the vehicle 740, and configuring it to communicate with the vehicle 740 via a wired or wireless connection (e.g., via Bluetooth). Although FIG. 7 illustrates a single ride-service computing device 748 at a particular location in the vehicle 740, the vehicle 740 may include several ride-service computing devices 748 in several different locations within the vehicle. As an example and not by way of limitation, the vehicle 740 may include four ride-service computing devices 748 located in the following places: one in front of the front-left passenger seat (e.g., driver's seat in traditional U.S. automobiles), one in front of the front-right passenger seat, one in front of each of the rear-left and rear-right passenger seats. In particular embodiments, ride-service computing device 748 may be detachable from any component of the vehicle 740. This may allow users to handle ride-service computing device 748 in a manner consistent with other tablet computing devices. As an example and not by way of limitation, a user may move ride-service computing device 748 to any location in the cabin or passenger compartment of the vehicle 740, may hold ride-service computing device 748, or handle ride-service computing device 748 in any other suitable manner. Although this disclosure describes providing a particular computing device in a particular manner, this disclosure contemplates providing any suitable computing device in any suitable manner.

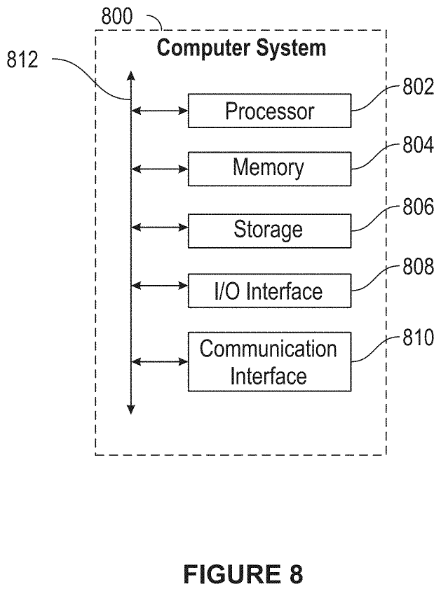

FIG. 8 illustrates an example computer system 800. In particular embodiments, one or more computer systems 800 perform one or more steps of one or more methods described or illustrated herein. In particular embodiments, one or more computer systems 800 provide the functionalities described or illustrated herein. In particular embodiments, software running on one or more computer systems 800 performs one or more steps of one or more methods described or illustrated herein or provides the functionalities described or illustrated herein. Particular embodiments include one or more portions of one or more computer systems 800. Herein, a reference to a computer system may encompass a computing device, and vice versa, where appropriate. Moreover, a reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 that are to be operated on by computer instructions; the results of previous instructions executed by processor 802 that are accessible to subsequent instructions or for writing to memory 804 or storage 806; or any other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs), be a multi-core processor, or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described in further detail below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware or software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware or software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or any other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a Bluetooth WPAN), a WI-FI network, a WI-MAX network, a cellular telephone network (such as, for example, a Global System for Mobile Communications (GSM) network), or any other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware or software, or both coupling components of computer system 800 to each other. As an example and not by way of limitation, bus 812 may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A or B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Methods described herein may vary in accordance with the present disclosure. Various embodiments of this disclosure may repeat one or more steps of the methods described herein, where appropriate. Although this disclosure describes and illustrates particular steps of certain methods as occurring in a particular order, this disclosure contemplates any suitable steps of the methods occurring in any suitable order or in any combination which may include all, some, or none of the steps of the methods. Furthermore, although this disclosure may describe and illustrate particular components, devices, or systems carrying out particular steps of a method, this disclosure contemplates any suitable combination of any suitable components, devices, or systems carrying out any suitable steps of the method.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, modules, elements, feature, functions, operations, or steps, any of these embodiments may include any combination or permutation of any of the components, modules, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A computer-implemented method comprising:
receiving, by a computing system, a context comprising attributes associated with an environment including an agent, wherein the attributes associated with the agent are determined based at least in part on sensor data captured by at least one vehicle;
generating, by the computing system, a first predictive trajectory for the agent based on a first trajectory prediction algorithm, wherein the first predictive trajectory is associated with a first performance metric;
generating, by the computing system, a second predictive trajectory for the agent based on a second trajectory prediction algorithm, wherein the second predictive trajectory is associated with a second performance metric, and wherein a plurality of trajectory prediction algorithms include the first trajectory prediction algorithm and the second trajectory prediction algorithm;
selecting, by the computing system, the first trajectory prediction algorithm of the plurality of trajectory prediction algorithms over the second trajectory prediction algorithm of the plurality of trajectory prediction algorithms as a selected trajectory prediction algorithm for the context based on a comparison of the first performance metric associated with the first trajectory prediction algorithm with the second performance metric associated with the second trajectory prediction algorithm;
training, by the computing system, a machine learning model based on training data including the context and the selected trajectory prediction algorithm to associate the context to a particular cluster of a plurality of clusters of contexts associated with the plurality of trajectory prediction algorithms; and
providing, by the computing system, the first trajectory prediction algorithm to one or more vehicles for use in navigating the one or more vehicles in the environment.

2. The computer-implemented method of claim 1, the method further comprising:
determining, by the computing system, a first observed position of the agent at a first time from the sensor data captured;
applying, by the computing system, the plurality of trajectory prediction algorithms to the agent at the first observed position to predict respective positions of the agent at a second time as predicted by the plurality of trajectory prediction algorithms;
determining, by the computing system, a second observed position of the agent at the second time from the sensor data captured; and
comparing, by the computing system, the second observed position and the respective positions to generate the first performance metric and the second performance metric.

3. The computer-implemented method of claim 1, wherein the selecting the first trajectory prediction algorithm over the second trajectory prediction algorithm further comprises:
determining, by the computing system, values associated with the context indicative of at least one of a timing criterion or a priority;
determining, by the computing system, a processing time associated with the first trajectory prediction algorithm based on the first performance metric; and
determining, by the computing system, that the processing time satisfies the timing criterion or the priority.

4. The computer-implemented method of claim 1, the method further comprising:
acquiring ground truth data extracted from a data store; and
evaluating the first trajectory prediction algorithm and the second trajectory algorithm based on movements of objects in the ground truth data.

5. The computer-implemented method of claim 1, the method further comprising:
determining, by the computing system, an outlier context absent in the plurality of clusters;
adding, by the computing system, an additional trajectory prediction algorithm to the plurality of trajectory prediction algorithms; and
associating, by the computing system, the outlier context to the additional trajectory prediction algorithm.

6. The computer-implemented method of claim 1, further comprising:
providing, by the computing system, a particular context associated with a particular agent;
determining, by the computing system, that the particular context is associated with the particular cluster;
selecting, by the computing system, the first trajectory prediction algorithm based on the particular context being associated with the particular cluster; and
determining, by the computing system, a trajectory for the particular agent based on the first trajectory prediction algorithm.

7. The computer-implemented method of claim 1, wherein the particular cluster includes one or more other contexts, the method further comprising:
associating, by the computing system, the first trajectory prediction algorithm to the one or more contexts included within the particular cluster.

8. The computer-implemented method of claim 1,
wherein the context comprises a plurality of agents including the agent, the method further comprising:
filtering, by the computing system, at least one agent of the plurality of agents based on a threshold likelihood of the at least one agent having an interaction with the one or more vehicles.

9. The computer-implemented method of claim 1, wherein the context comprises a plurality of agents including the agent, wherein the plurality of agents are associated with a plurality of priorities, and the method further comprises:
ranking, by the computing system, the plurality of agents based on the plurality of priorities.

10. The computer-implemented method of claim 1, the method further comprising:
tuning, by the computing system, the first trajectory prediction algorithm; and
evaluating, by the computing system, the first trajectory prediction algorithm on the agent to generate a performance metric associated with the first trajectory prediction algorithm.

11. A system comprising:
at least one processor; and
a memory storing instructions that, when executed by the at least one processor, cause the system to perform:
receiving a context comprising attributes associated with an environment including an agent, wherein the attributes associated with the agent are determined based at least in part on sensor data captured by at least one vehicle;
generating a first predictive trajectory for the agent based on a first trajectory prediction algorithm, wherein the first predictive trajectory is associated with a first performance metric;
generating a second predictive trajectory for the agent based on a second trajectory prediction algorithm, wherein the second predictive trajectory is associated with a second performance metric, and wherein a plurality of trajectory prediction algorithms include the first trajectory prediction algorithm and the second trajectory prediction algorithm;
selecting the first trajectory prediction algorithm of the plurality of trajectory prediction algorithms over the second trajectory prediction algorithm of the plurality of trajectory prediction algorithms as a selected trajectory prediction algorithm for the context based on a comparison of the first performance metric associated with the first trajectory prediction algorithm with the second performance metric associated with the second trajectory prediction algorithm;
training a machine learning model based on training data including the context and the selected trajectory prediction algorithm to associate the context to a particular cluster of a plurality of clusters of contexts associated with the plurality of trajectory prediction algorithms; and
providing the first trajectory prediction algorithm to one or more vehicles for use in navigating the one or more vehicles in the environment.

12. The system of claim 11, wherein the instructions cause the system to further perform:
determining a first observed position of the agent at a first time from the sensor data captured;
applying the plurality of trajectory prediction algorithms to the agent at the first observed position to predict respective positions of the agent at a second time as predicted by the plurality of trajectory prediction algorithms;
determining a second observed position of the agent at the second time from the sensor data captured; and
comparing the second observed position and the respective positions to generate the first performance metric and the second performance metric.

13. The system of claim 11, wherein the selecting the first trajectory prediction algorithm over the second trajectory prediction algorithm further comprises:
determining values associated with the context indicative of at least one of a timing criterion or a priority;
determining a processing time associated with the first trajectory prediction algorithm based on the first performance metric; and
determining that the processing time satisfies the timing criterion or the priority.

14. The system of claim 11, wherein the instructions cause the system to further perform:
acquiring ground truth data extracted from a data store; and
evaluating the first trajectory prediction algorithm and the second trajectory algorithm based on movements of objects in the ground truth data.

15. The system of claim 11, wherein the instructions cause the system to further perform:
determining an outlier context absent in the plurality of clusters;
adding an additional trajectory prediction algorithm to the plurality of trajectory prediction algorithms; and
associating the outlier context to the additional trajectory prediction algorithm.

16. A non-transitory computer-readable storage medium including instructions that, when executed by at least one processor of a computing system, cause the computing system to perform:
receiving a context comprising attributes associated with an environment including an agent, wherein the attributes associated with the agent are determined based at least in part on sensor data captured by at least one vehicle;
generating a first predictive trajectory for the agent based on a first trajectory prediction algorithm, wherein the first predictive trajectory is associated with a first performance metric;
generating a second predictive trajectory for the agent based on a second trajectory prediction algorithm, wherein the second predictive trajectory is associated with a second performance metric, and wherein a plurality of trajectory prediction algorithms include the first trajectory prediction algorithm and the second trajectory prediction algorithm;
selecting the first trajectory prediction algorithm of the plurality of trajectory prediction algorithms over the second trajectory prediction algorithm of the plurality of trajectory prediction algorithms as a selected trajectory prediction algorithm for the context based on a comparison of the first performance metric associated with the first trajectory prediction algorithm with the second performance metric associated with the second trajectory prediction algorithm;
training a machine learning model based on training data including the context and the selected trajectory prediction algorithm to associate the context to a particular cluster of a plurality of clusters of contexts associated with the plurality of trajectory prediction algorithms; and
providing the first trajectory prediction algorithm to one or more vehicles for use in navigating the one or more vehicles in the environment.

17. The non-transitory computer-readable storage medium of claim 16, wherein the instructions cause the computing system to perform the method further comprising:
determining a first observed position of the agent at a first time from the sensor data captured;
applying the plurality of trajectory prediction algorithms to the agent at the first observed position to predict respective positions of the agent at a second time as predicted by the plurality of trajectory prediction algorithms;
determining a second observed position of the agent at the second time from the sensor data captured; and
comparing the second observed position and the respective positions to generate the first performance metric and the second performance metric.

18. The non-transitory computer-readable storage medium of claim 16, wherein the selecting the first trajectory prediction algorithm over the second trajectory prediction algorithm further comprises:
determining values associated with the context indicative of at least one of a timing criterion or a priority;
determining a processing time associated with the first trajectory prediction algorithm based on the first performance metric; and
determining that the processing time satisfies the timing criterion or the priority.

19. The non-transitory computer-readable storage medium of claim 16, wherein the instructions cause the computing system to perform the method further comprising:
acquiring ground truth data extracted from a data store; and
evaluating the first trajectory prediction algorithm and the second trajectory algorithm based on movements of objects in the ground truth data.

20. The non-transitory computer-readable storage medium of claim 16, wherein the instructions cause the computing system to perform the method further comprising:
determining an outlier context absent in the plurality of clusters;
adding an additional trajectory prediction algorithm to the plurality of trajectory prediction algorithms; and
associating the outlier context to the additional trajectory prediction algorithm.
